(19) United States
(12) Patent Application Publication
(10) Pub. No.: US 2023/0042773 A1
(43) Pub. Date: Feb. 9, 2023

(54) NEURAL NETWORK COMPUTING DEVICE AND CONTROL METHOD THEREOF

(71) Applicant: INDUSTRY-ACADEMIC COOPERATION FOUNDATION, YONSEI UNIVERSITY, Seoul (KR)

(72) Inventors: William Jinho SONG, Seoul (KR); Chanho PARK, Seoul (KR); Bogil KIM, Seoul (KR); Sungmin RYU, Seoul (KR)

(73) Assignee: INDUSTRY-ACADEMIC COOPERATION FOUNDATION, YONSEI UNIVERSITY, Seoul (KR)

(21) Appl. No.: 17/883,010

(22) Filed: Aug. 8, 2022

(30) Foreign Application Priority Data
Aug. 9, 2021 (KR) 10-2021-0104333
Aug. 5, 2022 (KR) 10-2022-0098128

(51) Int. Cl. G06N 3/02

(52) U.S. Cl. CPC G06N 3/02

(57) ABSTRACT

Provided is a neural network computing device. The neural network computing device includes a memory which includes a plurality of memory hierarchies, and a processor configured to perform first scheduling for a first movement of the neural network computation data, which is transmitted and received between a first memory hierarchy, and a second memory hierarchy having a level higher than that of the first memory hierarchy, after the first scheduling is performed, perform second scheduling for a second movement of the neural network computation data, which is transmitted and received between the second memory hierarchy, and a third memory hierarchy having a level higher than that of the second memory hierarchy, and identify a neural network computation schedule for performing the convolution operation, based on a result of the first scheduling and a result of the second scheduling.

### CROSS-REFERENCE TO RELATED APPLICATION

This application claims priority under 35 U.S.C. § 119 to Korean Patent Application No. 10-2021-0104333, filed on Aug. 9, 2021, and Korean Patent Application No. 10-2022-0098128, filed on Aug. 5, 2022, in the Korean Intellectual Property Office, the disclosure of which is incorporated by reference herein in its entirety.

### BACKGROUND

### 1. Field

The disclosure relates to a neural network computing device and method for quickly determining a neural network computation schedule which serves as a criterion in determining when and where to store data required for a convolution operation in a neural network computing device.

### 2. Description of the Related Art

As artificial neural network technology has recently been developed, a lot of hardware with a neural network computing device for quickly processing convolution operations has been developed.

Data required for convolution operation is stored in the memory of the neural network computing device and is used for the convolution operation, and some of the data may be reused in each of a plurality of memory hierarchies while the convolution operation is performed. Neural network computation data cannot be transmitted and received between adjacent memory hierarchies without rules. Therefore, a neural network computation schedule including hardware mapping and a dataflow needs to be determined through a process called scheduling.

Once the neural network computation schedule is determined, the neural network computing device is able to calculate computation costs necessary for performing convolution operation. That is, when there are a plurality of schedule candidates, computation costs may be calculated for each of the schedule candidates, and an optimal schedule for performing convolution operation may be determined by comparing the computation costs.

However, there may be countless schedule candidates applicable to the neural network computing device, depending on the neural network data having a multidimensional structure, and hardware specifications of the neural network computing device. If computation costs are to be calculated for all schedule candidates in order to determine a schedule with the lowest computation cost, an excessively large amount of computations should be performed, thereby increasing time required for scheduling, which is a problem.

### SUMMARY

Provided are a neural network computing device capable of reducing time required for performing scheduling through bottom-up scheduling where scheduling for a low level section of the neural network computing device is performed first, and scheduling for a high level section is then performed, a method of controlling the neural network computing, and a computer program.

Provided are a neural network computing device capable of a neural network computation schedule having computation costs similar to those of a neural network computation schedule having the lowest computation costs while significantly reducing time required for performing scheduling, compared to a scheduling method of calculating computation costs for all schedule candidates applicable to the neural network computing device, a method of controlling the neural network computing device, and a computer program.

Additional aspects will be set forth in part in the description which follows and, in part, will be apparent from the description, or may be learned by practice of the presented embodiments of the disclosure.

According to an aspect of the disclosure, a neural network computing device for generating output data by performing a convolution operation of input data and weight data, the neural network computing device includes a memory which includes a plurality of memory hierarchies and is configured to store neural network computation data including the input data, the weight data, and the output data, and at least one processor configured to perform first scheduling for a first movement of the neural network computation data, which is transmitted and received between a first memory hierarchy, and a second memory hierarchy having a level higher than that of the first memory hierarchy, after the first scheduling is performed, perform second scheduling for a second movement of the neural network computation data, which is transmitted and received between the second memory hierarchy, and a third memory hierarchy having a level higher than that of the second memory hierarchy, and identify a neural network computation schedule for performing the convolution operation, based on a result of the first scheduling and a result of the second scheduling.

In an embodiment, the at least one processor may perform the first scheduling based on at least one of a plurality of strategies. The at least one processor may perform the second scheduling based on at least one of the plurality of strategies if the first scheduling is performed. The at least one processor may identify a plurality of schedule candidates based on a result of the first scheduling and a result of the second scheduling. The at least one processor may identify one of the plurality of schedule candidates as the neural network computation schedule. In a process, the plurality of strategies include a first strategy for enhancing a utilization rate of a low level memory hierarchy among the plurality of memory hierarchies, a second strategy for enhancing a utilization rate of a high level memory hierarchy among the plurality of memory hierarchies, a third strategy for keeping a balance between the utilization rate of the high level memory hierarchy and the utilization rate of the low level memory hierarchy, and a fourth strategy for preventing repeated transmission and reception of the neural network computation data.

In an embodiment, the at least one processor may perform the first scheduling and the second scheduling for each of a plurality of dataflow combinations, which are generated based on a dataflow of the first movement and a dataflow of the second movement, In the process, the dataflow may be determined based on a parameter about which data is reused among a plurality of neural network parameters of the neural network computation data.

In an embodiment, the at least one processor may perform the first scheduling based on the first strategy to minimize movement costs of the neural network computation data which performs the first movement. The at least one processor may perform the second scheduling based on the first strategy to minimize movement costs of the neural network computation data which performs the second movement. The movement costs may include at least one of energy and time required for transmission and reception of the neural network computation data.

In an embodiment, the at least one processor may perform the first scheduling based on the second strategy to maximize a data tile size of the neural network computation data which performs the first movement. The at least one processor may perform the second scheduling based on the second strategy to maximize a data tile size of the neural network computation data which performs the second movement.

In an embodiment, the at least one processor may perform the first scheduling based on the third strategy to maximize a number of mapping candidates for the second movement. The at least one processor may perform the second scheduling based on the third strategy to maximize the number of mapping candidates for the third movement of the neural network computation data which is transmitted and received between the third memory hierarchy and a fourth memory hierarchy having a level higher than that of the third memory hierarchy.

In an embodiment, the processor may perform the first scheduling based on the fourth strategy to prevent repeated transmission and reception of the neural network computation data in the second movement, and perform the second scheduling based on the fourth strategy to prevent repeated transmission and reception of the neural network computation data in the third movement of the neural network computation data which is transmitted between the third memory hierarchy and a fourth memory hierarchy having a level higher than that of the third memory hierarchy.

In an embodiment, in the process, the plurality of neural network parameters may include a plurality of input data parameters related to factors of the input data, a plurality of weight data parameters related to factors of the weight data, and a plurality of output data parameters related to factors of the output data. In the process, the dataflow may be one of an input stationary (IS) dataflow where data related to the input data parameters is reused, a weight stationary (WS) dataflow where data related to the weight data parameters is reused, and an output stationary (OS) dataflow where data related to the output data parameters is reused.

In an embodiment, in the process, the plurality of schedule candidates may satisfy constraint conditions, which are determined based on at least one of a storage capacity of the plurality of memory hierarchies, and a number of components including the plurality of memory hierarchies.

In an embodiment, the at least one processor may identify computation costs required for performing the convolution operation for each of the plurality of schedule candidates. In an embodiment, the at least one processor may identify a schedule candidate, which has the smallest computation costs among the plurality of schedule candidates, as the neural network computation schedule. In the process, the computation costs may include at least one of energy and time required for performing the convolution operation.

The neural network computing device may further include an operator for performing the convolution operation. The at least one processor may control the operator to perform the convolution operation based on the neural network computation schedule.

According to another aspect of the disclosure, a method of controlling a neural network computing device, which generates output data by performing a convolution operation of input data and weight data, and uses a memory which includes a plurality of memory hierarchies and is configured to store neural network computation data including the input data, the weight data, and the output data, includes performing first scheduling for a first movement of the neural network computation data, which is transmitted and received between a first memory hierarchy, and a second memory hierarchy having a level higher than that of the first memory hierarchy, after the first scheduling is performed, performing second scheduling for a second movement of the neural network computation data, which is transmitted and received between the second memory hierarchy, and a third memory hierarchy having a level higher than that of the second memory hierarchy, if the first scheduling is performed, and identifying a neural network computation schedule for performing the convolution operation, based on a result of the first scheduling and a result of the second scheduling.

In an embodiment, the performing of the first scheduling may include the performing the first scheduling based on at least one of a plurality of strategies. The performing of the second scheduling may include performing the second scheduling based at least one of the plurality of strategies after the first scheduling is performed. the identifying of the neural network computation schedule may include identifying a plurality of schedule candidates based on a result of the first scheduling and a result of the second scheduling, and identifying one of the plurality of schedule candidates, as the neural network computation schedule. In the process, the plurality of strategies may include a first strategy for enhancing a utilization rate of a low level memory hierarchy among the plurality of memory hierarchies, a second strategy for enhancing a utilization rate of a high level memory hierarchy among the plurality of memory hierarchies, a third strategy for keeping a balance between the utilization rate of the high level memory hierarchy and the utilization rate of the low level memory hierarchy, and a fourth strategy for preventing repeated transmission and reception of the neural network computation data.

In an embodiment, the performing of the first scheduling may include performs the first scheduling for each of a plurality of dataflow combinations, which are generated based on a dataflow of the first movement and a dataflow of the second movement. The performing of the second scheduling may include performing the second scheduling for each of the plurality of dataflow combinations. In the process, the dataflow may be determined based on a parameter about which data is reused among a plurality of neural network parameters of the neural network computation data.

In an embodiment, the performing of the first scheduling may include performing the first scheduling based on the first strategy to minimize movement costs of the neural network computation data which performs the first movement. The performing of the second scheduling may include performing the second scheduling based on the first strategy to minimize movement costs of the neural network computation data which performs the second movement. In the process the movement costs may include at least one of energy and time required for transmission and reception of the neural network computation data.

In an embodiment, the performing of the first scheduling may include performing the first scheduling based on the second strategy to maximize a data tile size of the neural network computation data which performs the first movement. The performing of the second scheduling may include performing the second scheduling based on the second strategy to maximize a data tile size of the neural network computation data which performs the second movement.

In an embodiment, the performing of the first scheduling may include performing the first scheduling based on the third strategy to maximize a number of mapping candidates for the second movement. The performing of the second scheduling may include performing the second scheduling based on the third strategy to maximize the number of mapping candidates for the third movement of the neural network computation data which is transmitted and received between the third memory hierarchy and a fourth memory hierarchy having a level higher than that of the third memory hierarchy.

In an embodiment, the performing of the first scheduling may include performing the first scheduling based on the fourth strategy to prevent repeated transmission and reception of the neural network computation data in the second movement. The performing of the second scheduling may include performing the second scheduling based on the fourth strategy to prevent repeated transmission and reception of the neural network computation data in the third movement of the neural network computation data which is transmitted between the third memory hierarchy and a fourth memory hierarchy having a level higher than that of the third memory hierarchy.

In an embodiment, in the process, The plurality of neural network parameters may include a plurality of input data parameters related to factors of the input data, a plurality of weight data parameters related to factors of the weight data, and a plurality of output data parameters related to factors of the output data. In the process, the dataflow may be one of an input stationary (IS) dataflow where data related to the input data parameters is reused, a weight stationary (WS) dataflow where data related to the weight data parameters is reused, and an output stationary (OS) dataflow where data related to the output data parameters is reused.

In an embodiment, the plurality of schedule candidates may satisfy constraint conditions which are determined based on at least one of a storage capacity of the plurality of memory hierarchies, and a number of components including the plurality of memory hierarchies.

In an embodiment, the identifying of the neural network computation schedule may include identifying computation costs required for performing the convolution operation for each of the plurality of schedule candidates, and identifying a schedule candidate, which has the smallest computation costs among the plurality of schedule candidates, as the neural network computation schedule. In the process, the computation costs may include at least one of energy and time required for performing the convolution operation.

In an embodiment, the method of controlling a neural network computing device may further include performing the convolution operation based on the identified neural network computation schedule.

In an embodiment, the method of controlling a neural network computing device may provide a computer program stored in a non-transitory computer-readable recording medium to execute the method of controlling a neural network computing device.

According to the disclosure, time required for performing scheduling may be reduced through bottom-up scheduling.

In addition, according to the disclosure, a neural network computation schedule having computation costs similar to those of a neural network computation schedule having the lowest computation costs may be found while significantly reducing time required for performing scheduling.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a neural network computing device according to an embodiment;

FIG. 2 is a diagram of a multilevel structure of a neural network computing device according to an embodiment;

FIG. 3 is a diagram of hardware mapping and a dataflow according to an embodiment of the present disclosure;

FIG. 4 is a diagram of bottom-up scheduling according to an embodiment of the present disclosure;

FIG. 5A, FIG. 5B and FIG. 5C are diagrams of a neural network parameter according to an embodiment of the present disclosure;

FIG. 6 is a diagram of a scheduling table according to an embodiment of the present disclosure;

FIG. 7A, FIG. 7B and FIG. 7C are diagrams illustrating a method of calculating the number of combinations of mapping values, which may be allocated to a scheduling table, according to an embodiment of the present disclosure;

FIG. 8A, FIG. 8B and FIG. 8C are diagrams illustrating a process of performing bottom-up scheduling using a scheduling table, according to an embodiment of the present disclosure;

FIG. 9 is a diagram illustrating a method of calculating the data tile size and movement costs of neural network computation data, based on mapping values allocated to a scheduling table, according to an embodiment of the present disclosure;

FIG. 10A and FIG. 10B are diagrams illustrating the combination of mapping values, which satisfy constraint conditions, according to an embodiment of the present disclosure;

FIG. 11 is a flowchart illustrating a method of controlling a neural network computing device, according to an embodiment of the present disclosure;

FIG. 12A and FIG. 12B show a table and a graph of comparing a scheduling method according to an embodiment of the present disclosure with a scheduling method according to a conventional art; and

FIG. 13 is a graph for explaining the accuracy of a neural network computation schedule identified by a scheduling method according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the description. As used herein, the term “and/or” includes any and all combinations of one or more of the associated listed items. Expressions such as “at least one of,” when preceding a list of elements, modify the entire list of elements and do not modify the individual elements of the list.

Like reference numerals refer to like elements throughout the specification. No all the elements of the embodiments of the disclosure are not described herein, and the disclosed contents are omitted.

Throughout the specification, when a portion “includes” an element, another element may be further included, rather than excluding the existence of the other element, unless otherwise described.

It will be understood that although the terms “first,” “second,” etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

In addition, in the disclosure, reference numerals indicating operations are used for the convenience of description and do not indicate the order of the operations, and the operations may be performed in a different order, unless the context clearly indicates otherwise.

In the disclosure, “neural network” is a representative example of an artificial neural network model that simulates the brain nerve, and is not limited to an artificial neural network model which uses a certain algorithm. The neural network may also be referred to as a deep neural network.

In the disclosure, “neural network accelerator” may mean a processor particularly optimized to process a neural network workload.

In the disclosure, “memory hierarchy” may mean memory distinguished hierarchically according to the processing speed and capacity. As the level of the memory hierarchy decreases, the capacity of the memory may increase, but the processing speed may decrease. In contrast, the level of the memory hierarchy increases, the capacity of the memory may decrease, but the processing speed may increase.

In the present disclosure, “neural network computation data” may mean data used to perform a convolution operation. The neural network computation data may include input data and weight data used to perform a convolution operation, and output data generated by the convolution operation.

In addition, as used herein, “data tile” may mean a subset of neural network data stored in a low level memory hierarchy, which is to be loaded to a high level memory hierarchy.

Hereinafter, the embodiments of the present disclosure will be described with reference to the accompanying drawings.

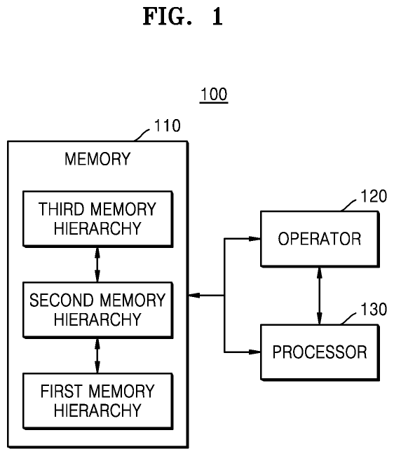

FIG. 1 is a block diagram of a neural network computing device according to an embodiment.

Referring to FIG. 1, a neural network computing device 100 according to an embodiment may include a memory 110, an operator 120, and a processor 130.

The memory 110 may store neural network computation data including input data, weight data, and output data.

In an embodiment, the memory 110 may be a volatile memory, such as dynamic random access memory (DRAM) or static random access memory (SRAM), which is used to temporarily store data, but is not limited thereto. In an embodiment, the memory 110 may also include a nonvolatile memory, such as read only memory (ROM), erasable programmable read only memory (EPROM), or electrically erasable programmable read only memory (EEPROM).

In an embodiment, the memory 110 may include a plurality of memory hierarchies 111, 112, and 113. Here, the plurality of memory hierarchies 111, 112, and 113 may have relative levels therebetween. In an embodiment, the level of a second memory hierarchy 112 may be higher than that of a first memory hierarchy 111. In addition, the level of a third memory hierarchy 113 may be higher than that of the second memory hierarchy 112.

The operator 120 may perform a convolution operation using neural network computation data stored in the memory 110.

In an embodiment, the operator 120 may include a multiply-and-accumulate (MAC) operator. In this case, the operator 120 may receive input data and weight data from the memory 110, and may generate output data by performing MAC operation for the received input data and weight data.

The processor 130 may be electrically connected to the memory 110 and the operator 120 and may control overall operations and functions of the neural network computing device 100.

In an embodiment, the processor 130 may include a central processing unit (CPU) or an application processor (AP) and may execute one or more software programs stored in the memory, according to one or more instructions stored in the memory 110.

In an embodiment, the neural network computing device 100 may include a neural network accelerator for performing a convolution operation. In an embodiment, the neural network accelerator may include an operator 120 and at least one memory hierarchy among a plurality of memory hierarchies 111, 112, and 113.

In an embodiment, a memory hierarchy, which is included in the neural network accelerator, may mean an on-chip memory. For example, a memory hierarchy, which is not included in the neural network accelerator, may mean an off-chip memory. The level of the memory hierarchy of the off-chip memory may be lower than that of the on-chip memory.

The neural network accelerator may include a logic circuit and an arithmetic circuit, and may process data according to a program provided from the memory 110 and generate a control signal according to the result of processing the data.

As such, the neural network computing device 100 may generate output data by performing an convolution operation for input data and weight data through a neural network accelerator.

In an embodiment, the convolution operation may be performed for layers of a deep neural network composed of a plurality of layers.

In an embodiment, layers of the neural network may be expressed in a modified form of a convolution layer. For example, the layers may include a depth-wise convolutional layer, a point-wise convolutional layer, and a fully-connected layer.

During the learning process through the deep neural network, forward propagation may be used in inferring or classifying initial input data using a pre-trained weight. In addition, in the backward propagation process, a weight may be updated and trained.

In an embodiment, a neural network computing device 100 may perform a scheduling for the convolution operation of hardware which accelerates the forward propagation.

However, the role of the neural network computing device 100 is not limited to performing a scheduling for the convolution operation of the deep neural network. That is, the neural network computing device 100 according to an embodiment may also perform a scheduling for the convolution operation of an arbitrary machine learning, such as another kind of convolutional neural network (CNN).

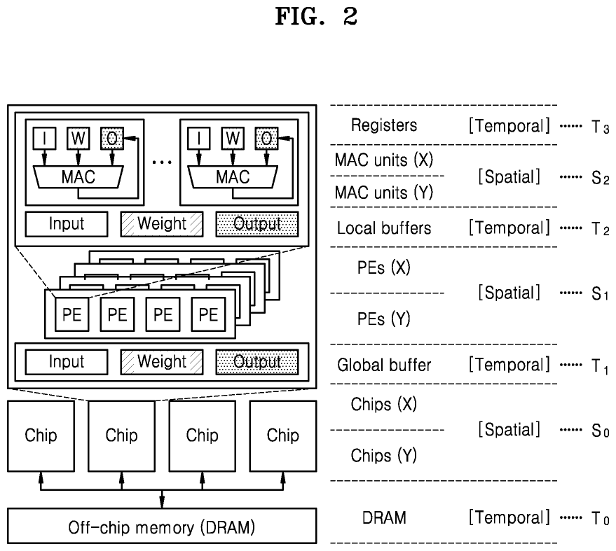

FIG. 2 is a diagram of a multilevel structure of a neural network computing device according to an embodiment.

Referring to FIG. 2, the neural network computing device 100 may have a multilevel structure in which a spatial level and a temporal level are alternately arranged.

In an embodiment, the neural network computing device 100 may include a plurality of components including a plurality of memory hierarchies and a plurality of components including the memory hierarchies.

For example, a plurality of memory hierarchies of the neural network computing device 100 may include DRAM, a global buffer, a local buffer, and a register.

In an embodiment, a plurality of components of the neural network computing device 100 may include a plurality of cores including a global buffer, a plurality of processing elements (PE) including a local buffer, and a plurality of MAC operators including a register.

Here, the plurality of components may mean a spatial level [S] in a plurality of levels of the neural network computing device 100. In the spatial level of the neural network computing device 100, a plurality of components, which are spatially arranged, may perform data-level parallelism while performing the convolution operation.

In an embodiment, the plurality of memory hierarchies may mean the temporal level [T] of the hierarchy of the neural network computing device 100. In the temporal level of the neural network computing device 100, neural network computation data may be moved between adjacent memory hierarchies during the convolution operation.

In the spatial level and the temporal level of the neural network computing device 100, the reuse of data may be utilized in different ways. In an embodiment, in the spatial level, the spatial reuse of data may be utilized through data-level parallelism. In an embodiment, in the temporal level, some data is maintained among data tiles loaded from a low level memory hierarchy, and the temporal reuse of data may be utilized by temporarily reusing the maintained data.

In an embodiment, the data reuse, which is utilized in the spatial level and the temporal level of the neural network computing device, may reduce the number of times of access to a low level memory hierarchy which is relatively high in the movement costs required for the data movement. Through this, it is possible to reduce the computation costs required for performing the convolution operation of the neural network computing device 100.

Referring to FIG. 2 again, neural network computation data may be transmitted and received between adjacent memory hierarchies. For example, the neural network computation data may be transmitted and received between DRAM and a global buffer, between a global buffer and DRAM, and between a local buffer and a register.

In an embodiment, DRAM may store neural network computation data. In an embodiment, some of neural network data stored in the DRAM may be data tiles and may be transmitted and received between DRAM and a global buffer to which data tiles are allocated.

The transmission and reception of neural network computation data may be performed between a global buffer and a local buffer and between a local buffer and a register, in the same manner.

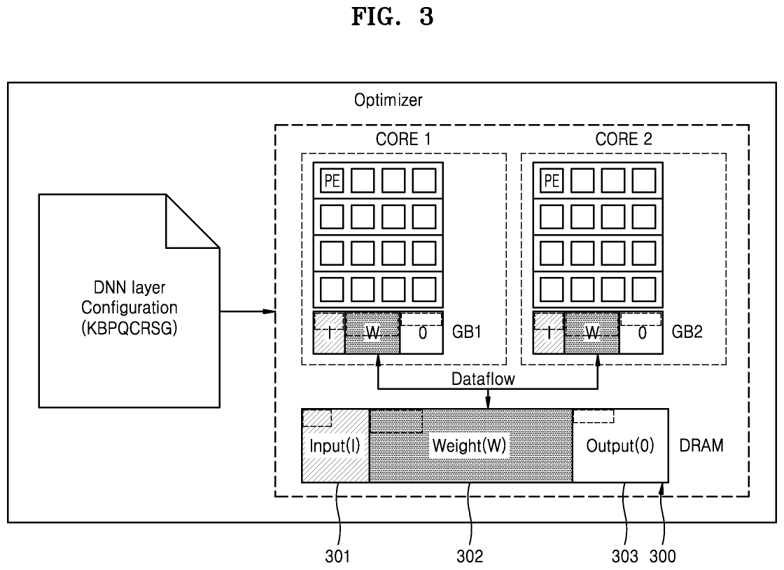

The neural network computation data may be transmitted and received between adjacent memory hierarchies, based on the neural network computation schedule identified through scheduling. The neural network computation schedule may be determined based on hardware mapping and a dataflow, and the details thereof will be described later with reference to FIG. 3.

In addition, there may be countless neural network computation schedules, which may be selected by the neural network computing device, according to the multidimensional structure of neural network computation data, and the hardware specification of the neural network computing device 100. As such, the neural network computing device 100 may perform scheduling for identifying a neural network computation schedule, which minimizes computation costs required for performing the convolution operation, among countless schedule candidates.

However, if computation costs are to be calculated for all schedule candidates during the scheduling process, excessive computations are required. Accordingly, computation costs required for performing a scheduling may increase.

Therefore, the neural network computing device 100 according to an embodiment may perform the first scheduling for a first movement for neural network computation data which is transmitted and received between a first memory hierarchy and a second memory hierarchy which is higher than the first memory hierarchy in the level. If the first scheduling is performed, the neural network computing device 100 may perform the second scheduling for a second movement of neural network computation data which is transmitted and received between the second memory hierarchy and a third memory hierarchy which is higher than the second memory hierarchy in the level.

In an embodiment, the neural network computing device 100 may identify a neural network computation schedule, based on the result of the first scheduling and the result of the second scheduling.

As such, the neural network computing device 100 may reduce time required for scheduling, by calculating computation costs for only selected schedule candidates without calculating computation costs for all schedule candidates which may be applicable to the neural network computing device 100. Furthermore, the neural network computation schedule identified through the scheduling may have computation costs similar to those of a schedule candidate having the lowest computation costs, among all schedule candidates.

The neural network computing method according to embodiments of the present disclosure may be implemented in the form of a program which may be run by at least one of the neural network computing device 100, the neural network accelerator, and the processor 130.

Here, the program may include a program command, a data file, and a data structure alone or in combination. The program may be designed and manufactured using machine code or advanced language code. The program may be specially designed to implement the method for modifying the above-described code, or may be implemented using various functions or definitions that may be known to one of ordinary skill in the computer software field and may be used. The program for implementing the information displaying method described above may be recorded in a recording medium readable by at least one of the neural network computing device 100, the neural network accelerator, and the processor 130. Here, the recording medium may be a memory 110.

The memory 110 may store a program for performing operations described above and operations to be described later, and the memory 110 may run the stored program. When there are a plurality of processors 130 and memories 110, they may be integrated in one chip or may be positioned at physically separated locations.

FIG. 3 is a diagram of hardware mapping and a dataflow according to an embodiment of the present disclosure;

Referring to FIG. 3, neural network computation data 300 may be transmitted and received between adjacent memory hierarchies according to the neural network computation schedule.

In an embodiment, the processor 130 may organize some of neural network data 300, which is stored in a low level memory hierarchy DRAM among adjacent memory hierarchies, as a plurality of data tiles. The data tiles may include part of input data 301, part of weight data 302, and part of output data 303 of the neural network data.

The processor 130 may allocate a plurality of data tiles to at least one component CORE 1 or CORE 2 including a high level memory hierarchy GB1 or GB2 among adjacent memory hierarchies.

The processor 130 may control high level memory hierarchies GB1 and GB2 to load a plurality of data tiles, which are allocated to components CORE 1 and CORE 2 including the high level memory hierarchies GB1 and GB2, from a low level memory hierarchy DRAM.

In an embodiment, the processor 130 may allocate a plurality of data tiles to all of the plurality of components including a high level memory hierarchy, but the present disclosure is not limited thereto, and the data tiles may also be allocated to only some of the components.

In an embodiment, the size of the allocated data tile may be determined based on the storage capacity of the memory hierarchy of the component to which the data tile is allocated.

In an embodiment, the data tiles may include an input data tile, a weight data tile, and an output data tile, and the sizes thereof may be individually determined.

Likewise, the processor 130 may need to determine the size of the data tile of neural network computation data 300, and a plurality of components to which the data tiles are allocated, in order allow the neural network computation data 300 to be transmitted and received between adjacent memory hierarchies. This determination process may be referred to as hardware mapping.

In addition, the processor 130 may determine the order in which a plurality of data tiles are loaded, based on the neural network computation schedule.

In an embodiment, when a plurality of data tiles are allocated to the same component CORE 1 and the allocated data tiles are sequentially loaded from the low level memory hierarchy DRAM to the high level memory hierarchy GB1, there may be redundant data between data tiles loaded before a specific point of time and data tiles loaded after the specific point of time.

As such, the processor 130 may continually store some of redundant data between data tiles loaded before a specific point of time and data tiles loaded after the specific point of time in the high level memory hierarchy GB1. The processor 130 and may load only data tiles except for data stored among data tiles loaded after the specific point of time, and reuse redundant data between data tiles.

Moreover, the redundant data may be determined according to the order in which the plurality of allocated data tiles are loaded. In other words, if the order, in which the plurality of allocated data tiles are loaded, is changed, the reused redundant data may also be changed.

As such, the order in which the plurality of allocated data tiles are loaded may be determined so that data, which is related to a certain parameter among a plurality of neural network parameters of the neural network computation data, may be reused in memory hierarchies.

Likewise, the data tile loading order, which is determined based on the parameter about which related data is reused among a plurality of neural network parameters, may be referred to as a dataflow.

In an embodiment, the dataflow may include an input stationary (IS) dataflow where data related to input data parameters is reused, a weight stationary (WS) dataflow where data related to weight data parameters is reused, and an output stationary (OS) dataflow where data related to output data parameters is reused. However, the dataflow is not limited thereto and may vary depending on the hardware structure of the neural network computing device 100.

Likewise, neural network computation data 300 cannot be transmitted and received between adjacent memory hierarchies without rules. Therefore, a neural network computation schedule including hardware mapping and a dataflow needs to be determined through scheduling.

The optimization of the neural network computing device 100 may mean scheduling for determining an efficient schedule for one neural network layer. The neural network computing device 100 according to an embodiment may determine optimal hardware mapping and dataflow by performing optimization of the neural network computing device 100, based on the neural network parameter of the neural network computation data 300.

Once the hardware mapping and dataflow for the neural network computation data, which is transmitted and received between all of the memory hierarchies of the neural network computing device 100, are determined, the neural network computing device 100 may be able to calculate computation costs required for performing the convolution operation.

Here, the computation costs may include at least one of energy and time required for performing the convolution operation. In addition, the computation costs may be determined based on the movement costs of neural network computation data transmitted and received between adjacent memory hierarchies.

Various schedule candidates may be generated depending on the combination of the hardware mapping and the dataflow which may be implemented in the neural network computing device 100. The schedule requiring the lowest computation costs may be determined by comparing computation costs for the plurality of schedule candidates.

However, there may be myriads of schedule candidates applicable to the neural network computing device 100, depending on the neural network data having a multidimensional structure, and hardware specifications of the neural network computing device 100. Thus, if computation costs are to be calculated for all schedule candidates in order to determine a schedule with the lowest computation cost, an excessively large amount of computations have be performed, thereby increasing time required for scheduling, which is a problem.

Therefore, when the scheduling is performed, it may be desirable to determine a schedule with computation costs close to the lowest computation costs through certainly a small amount of computations, rather than determining a schedule with the lowest computation costs by calculating computation costs for all schedule candidates.

As such, the neural network computing device 100 according to an embodiment may reduce time required for determining the optimal schedule through bottom-up scheduling in which movement costs of partial neural network computation data generated in a temporal level are sequentially calculated from the lowest level of the neural network computing device 100.

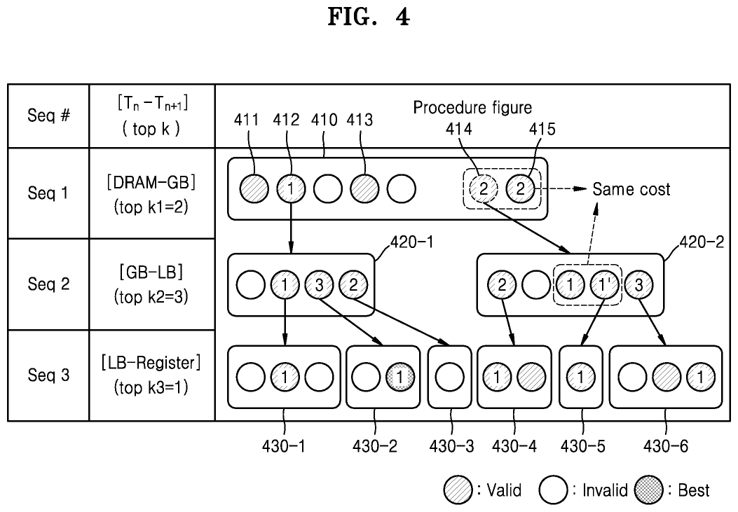

FIG. 4 is a diagram of bottom-up scheduling according to an embodiment of the present disclosure.

Referring to FIG. 4, the processor 130 may sequentially perform scheduling for the movement of neural network computation data, which is transmitted and received between adjacent memory hierarchies of the neural network computing device 100. The scheduling may be performed from the lowest level section to the highest level section, which may be referred to as bottom-up scheduling.

As shown in FIG. 4, the processor 130 may perform hardware mapping for neural network data, which is transmitted and received between adjacent memory hierarchies of the lowest level section, by performing scheduling in a first sequence Seq 1. Furthermore, the processor 130 may perform hardware mapping for neural network data, which is transmitted and received between adjacent memory hierarchies of the next higher level section, by performing scheduling in a second sequence Seq 2. Furthermore, the processor 130 may perform hardware mapping for neural network data, which is transmitted and received between adjacent memory hierarchies of the next higher level section, in a third sequence Seq 3.

In an embodiment, the processor 130 may identify a plurality of mapping candidates in each sequence. The mapping candidates may correspond to the size of the data tile of neural network data, which may be determined by the hardware mapping performed in the corresponding sequence, and the combination of a plurality of components, to which the data tile is allocated.

For example, the processor 130 may identify a plurality of mapping candidates 410 in the first sequence Seq 1, identify a plurality of mapping candidates 420-1 and 420-2 in the second sequence Seq 2, and identify a plurality of mapping candidates 430-1, 430-2, 430-3, 430-4, 430-5 and 430-6 in the third sequence Seq 3.

The processor 130 may identify mapping candidates which satisfy constraint conditions, among a plurality of mapping candidates. The mapping candidates, which satisfy constraint conditions, may mean mapping candidates which may be actually implemented in the neural network computing device 100, among a plurality of mapping candidates.

For example, the processor 130 may determine mapping candidates 411, 412, 413, 414 and 415, which satisfy constraint conditions, among a plurality of mapping candidates 410 in the first sequence Seq 1.

In an embodiment, some of the mapping candidates identified in each sequence may require a size of the data tile, which cannot be implemented in the neural network computing device 100, and the combination of a plurality of components to which the data tile is allocated.

As such, the processor 130 may identify mapping candidates corresponding to the size of the data tile, which may be actually implemented in the neural network computing device 100, and the combination of a plurality of components to which the data tile is allocated.

The processor 130 may perform hardware mapping in each sequence by selecting one of mapping candidates which satisfy constraint conditions in each sequence.

Moreover, a plurality of mapping candidates, which are identified in the next sequence, may vary depending on the mapping candidate selected in a certain sequence. For example, a plurality of mapping candidates 420-1, which are identified in the second sequence Seq 2 when a first mapping candidate 412 is selected in the first sequence Seq 1, may be different from a plurality of mapping candidates 420-2, which are identified in the second sequence Seq 2 when a second mapping candidate 414 is selected in the first sequence Seq 1.

The processor 130 may identify a plurality of schedule candidates, based on the combination of mapping candidates selected in each sequence. The processor 130 identifies one of the plurality of schedule candidates as the neural network computation schedule.

As illustrated, when the bottom-up scheduling is performed, the mapping candidates selected in the previous sequence may influence the number of mapping candidates selectable in the next sequence. That is, as the sequence proceeds, the number of mapping candidates selectable in each sequence may significantly decrease.

That is, the neural network computing device 100 according to an embodiment of the present disclosure may generate, through the bottom-up scheduling, a less number of mapping candidate combinations, compared to the method of determining mapping candidate combinations by simultaneously performing hardware mapping for all levels. The generated mapping candidate combinations may correspond to a plurality of schedule candidates, for which the computation costs should be calculated during the scheduling process.

As such, the neural network computing device 100 according to the present disclosure is tens of times faster than the brute-force scheduling method of determining the optimal neural network computation schedule by calculating computation costs for each of all schedule candidates and comparing the calculated computation costs.

In an embodiment, the processor 130 may perform the first scheduling based on at least one of a plurality of strategies. The processor 130 may perform the second scheduling based on at least one of the plurality of strategies after the first scheduling is performed. The processor 130 may identify a plurality of schedule candidates based on a result of the first scheduling and a result of the second scheduling. Here, the level section of the neural network computing device 100 in which the second scheduling is performed may be a higher-level section than the level section of the neural network computing device 100 in which the first scheduling is performed.

In an embodiment, the plurality of strategies may include a first strategy for enhancing the utilization rate of a low level memory hierarchy, a second strategy for enhancing the utilization rate of a high level memory hierarchy, a third strategy for keeping a balance between the utilization rate of the high level memory hierarchy and the utilization rate of the low level memory hierarchy, and a fourth strategy for preventing repeated transmission and reception of neural network computation data.

In an embodiment, the processor 130 may perform scheduling based on the first strategy. Specifically, the processor 130 may perform scheduling to minimize movement costs of neural network computation data which is transmitted and received between adjacent memory hierarchies based on the first strategy.

In an embodiment, the movement costs of neural network computation data may include at least one of energy and time required for transmission and reception of the neural network computation data.

To this end, the processor 130 may determine movement costs for each of a plurality of mapping candidates which satisfy constraint conditions in each sequence.

In an embodiment, the processor 130 may perform hardware mapping by selecting a mapping candidate, which has the lowest movement costs, among a plurality of mapping candidates. However, the present disclosure is not limited thereto, and the processor 130 may perform hardware mapping by selecting mapping candidates, which are included in a predetermined ranking in terms of the movement costs, among a plurality of mapping candidates.

Referring to FIG. 4, the processor 130 may perform scheduling based on the first strategy in all sequences. Values, which are represented by top k1, top k2, and top k3, may mean the ranking of movement costs which may be selected as mapping candidates in each sequence.

For example, “top k2=3” may mean that the three best mapping candidates in terms of the movement costs will be selected among mapping candidates which satisfy constraint conditions in the second sequence. Likewise, “top k3=1” may mean that the top-ranked mapping candidate in terms of the movement costs will be selected among mapping candidates which satisfy constraint conditions in the third sequence.

In an embodiment, the processor 130 may perform hardware mapping under a condition that top k is 1. In other words, hardware mapping may be performed to minimize movement costs of neural network computation data which is transmitted and received between adjacent memory hierarchies of all levels.

Assume that the processor 130 determines top k value for all orders as 1 (i.e., the processor 130 identifies a neural network computation schedule by performing hardware mapping of always selecting a mapping candidate having the lowest movement costs in all level sections). In this case, experiments show that the difference between the computation costs of the neural network computation schedule identified as such, and the computation costs of a neural network computation schedule having the lowest computation costs is less than 1%. Some experiments even show the same the computation costs.

In an embodiment, the processor 130 may first select mapping candidates from a low level of the neural network computing device 100, which has relatively large movement costs, by performing hardware mapping based on the first strategy, and may later select mapping candidates of a high level of the neural network computing device 100, which has relatively small movement costs. As such, the processor 130 may identify a plurality of schedule candidates having computation costs similar to the computation costs of a neural network computation schedule having the lowest computation costs.

In FIG. 4, the processor 130 performs scheduling based on the first strategy in all sequences, but the present invention is not limited thereto, and scheduling may be performed based on other strategies in each sequence. For example, the processor 130 may perform the first scheduling based on a first strategy, and after the first scheduling is performed, perform the second scheduling based on one of the second strategy, the third strategy, and the fourth strategy.

In an embodiment, the processor 130 may perform scheduling based on the second strategy. Specifically, the processor 130 may perform bottom-up scheduling to maximize the data tile size of neural network computation data which is transmitted and received between adjacent memory hierarchies, based on the second strategy.

To this end, the processor 130 may identify the data tile size of neural network computation data which is transmitted and received between adjacent memory hierarchies for each of the plurality of mapping candidates which satisfy constraint conditions in each sequence.

In an embodiment, the processor 130 may perform hardware mapping by selecting a mapping candidate which has the largest data tile size, among a plurality of mapping candidates. However, the present disclosure is not limited thereto, and the processor 130 may perform hardware mapping by selecting mapping candidates which are within a predetermined ranking in terms of the data tile size, among a plurality of mapping candidates.

In an embodiment, the processor 130 selects mapping candidates having a large data tile size, which are allocated to a high level memory hierarchy, by performing hardware mapping based on the second strategy. As such, the processor 130 may identify a plurality of schedule candidates capable of enhancing the utilization rate of components including a high level memory hierarchy.

In an embodiment, the processor 130 may perform scheduling based on the third strategy. Specifically, the processor 130 may perform bottom-up scheduling to maximize the number of mapping candidates which may be identified in the next sequence, based on the third strategy.

To this end, the processor 130 may identify the number of mapping candidates, which may be identified in the next sequence, for each of the plurality of mapping candidates which satisfy constraint conditions in each sequence.

In an embodiment, the processor 130 may select a mapping candidate having the largest number of mapping candidates, which may be identified in the next sequence, among a plurality of mapping candidates, and perform hardware mapping for the selected mapping candidate. However, the present disclosure is not limited thereto, and the processor 130 may select mapping candidates within a predetermined ranking in terms of the number of mapping candidates, which may be identified in the next sequence, among a plurality of mapping candidates, and perform hardware mapping for the selected mapping candidates.

In an embodiment, the processor 130 selects mapping candidates, which provide more flexibility of hardware mapping of the next sequence, by performing hardware mapping based on the third strategy. As such, the processor 130 may identify a plurality of schedule candidates for keeping a balance between the utilization rate of components including a high level memory hierarchy and components including a low level memory hierarchy.

In an embodiment, the processor 130 may perform scheduling based on the fourth strategy. Specifically, the processor 130 may perform scheduling based on the fourth strategy so that neural network computation data which is transmitted and received between adjacent memory hierarchies of the next level section. Here, the next level section may mean a level section of the neural network computing device(100) where scheduling is to be performed in the next sequence.

To this end, the processor 130 may identify neural network computation data which is not influenced by the dataflow of neural network computation data which is transmitted and received in the next level section. For example, when the dataflow of neural network computation data, which is transmitted and received in the next level section, is an input-fixed dataflow, the processor 130 may identify data, which is not influenced by the dataflow, as weight data and output data. In addition, the processor 130 may identify the data tile size of neural network computation data, which is not influenced by the dataflow, for each of a plurality of mapping candidates which satisfy constraint conditions.

In an embodiment, the processor 130 may select mapping candidates in which the data tile size of neural network computation data, which is not influenced by the dataflow, is smaller than that of the storage capacity of a second-high level memory hierarchy, among a plurality of mapping candidates, and perform hardware mapping for the selected mapping candidates.

The second-high memory hierarchy may mean a high level memory hierarchy among adjacent memory hierarchies of the next level section. The storage capacity of the second-high level memory hierarchy may mean the total sum of storage capacities of one high level memory hierarchy and a plurality of second-high level memory hierarchies where neural network computation data is transmitted and received.

For example, referring to FIG. 4, when the processor 130 performs scheduling based on the fourth strategy in the first sequence, the second-high level memory hierarchy may be a local buffer, which is a high level hierarchy of the next level section, and the storage capacity of the second-high level memory hierarchy may mean the total sum of storage capacities of one global buffer and a plurality of local buffers which transmit and receive neural network computation data.

In an embodiment, there may be a plurality of mapping candidates in which the data tile size of neural network computation data, which is not influenced by the dataflow, is smaller than the storage capacity of a second-high level memory hierarchy. As such, the processor 130 may select a mapping candidate having the lowest movement costs, among a plurality of mapping candidates. However, the present disclosure is not limited thereto, and the processor 130 may select mapping candidates of which the movement costs are within a predetermined ranking among a plurality of mapping candidates, and perform hardware mapping for the selected mapping candidates.

In an embodiment, the storage capacity of the second-high level memory hierarchy may be individually allocated for each type of the neural network computation data. In this case, the processor 130 may select mapping candidates in which the data tile size of each type of neural network computation data, which is not influenced by the dataflow, is smaller than the storage capacity allocated to each type of the neural network computation data of the second-high level memory hierarchy, and perform hardware mapping for the selected mapping candidates.

In an embodiment, the processor 130 may select mapping candidates capable of reducing the number of times of movement of neural network computation data in the next level section by performing hardware mapping based on the fourth strategy. As such, the processor 130 may identify a plurality of schedule candidates where neural network computation data is not repeatedly transmitted and received.

In an embodiment, the processor 130 may select each of a plurality of mapping candidates satisfying constraint conditions when scheduling the uppermost level section of the neural network computing device 100. That is, it may not be necessary to select a mapping candidate based on one or more of the first to fourth strategies because the scheduling for the highest level section is last in the scheduling order. Accordingly, the processor 130 may select each of a plurality of mapping candidates satisfying constraint conditions without selecting a mapping candidate based on the first to fourth strategies.

Likewise, the neural network computing device 100 according to an embodiment of the present disclosure may perform scheduling for each of a plurality level sections of the neural network computing device 100 based on one of various strategies, in order to identify the optimal neural network computation schedule. In addition, a plurality of schedule candidates may be identified based on combinations of mapping candidates selected through scheduling for each of the plurality of level sections.

Particularly, when the neural network computing device 100 identifies a plurality of schedule candidates by performing scheduling based on all of the first to fourth strategies, the probability of identifying a neural network computation schedule having computation costs close to the lowest computation costs may increase, because the first strategy, the second strategy, the third strategy, and the fourth strategy may mutually cover blind spots of a plurality of mapping candidates which may be identified according to each strategy.

In an embodiment, the processor 130 may perform bottom-up scheduling for each of a plurality of dataflow combinations.

In an embodiment, neural network computation data may be transmitted and received between adjacent memory hierarchies according to various dataflows. In an embodiment, a plurality of dataflow combinations may be generated, based on various dataflows of neural network computation data which are transmitted and received between adjacent memory hierarchies.

The dataflow may be one of an input stationary (IS) dataflow where data related to the input data parameters is reused, a weight stationary (WS) dataflow where data related to the weight data parameters is reused, and an output stationary (OS) dataflow where data related to the output data parameters is reused. For example, in FIG. 4, assuming that neural network computation data may be transmitted and received according to three dataflows IS, OS, and WS in the first sequence, may be transmitted and received according to two dataflows WS and OS in the second sequence, and may be transmitted and received according to two dataflows IS and WS in the third sequence, a total of 12 dataflow combinations may be generated.

The processor 130 may perform scheduling for each of 12 dataflow combinations, based on at least one of the first strategy, the second strategy, and the third strategy described above.

In an embodiment, the processor 130 may perform scheduling for each of a plurality of dataflow combinations, based on the first strategy or the fourth strategy.

Specifically, in each sequence, movement costs of each of the plurality of mapping candidates which satisfy constraint conditions may vary depending on the dataflow of neural network computation data. That is, different mapping candidates may be selected depending on the neural network dataflow in which hardware mapping is performed in each sequence. As such, combinations of different mapping candidates may be selected for each of a plurality of dataflow combinations.

In an embodiment, the processor 130 may perform scheduling for each of a plurality of dataflow combinations, based on the second strategy or the third strategy.

Specifically, the second strategy and third strategy do not consider movement costs of neural network data in each sequence. That is, the same mapping candidate may be selected regardless of the neural network dataflow in which hardware mapping is performed in each sequence. As such, the mapping candidate may be selected for each of a plurality of dataflow combinations.

However, computation costs required for convolution operation may vary depending on the dataflow combination even for the combinations of the same mapping candidates. That is, a schedule candidate, which has the lowest computation costs among a plurality of schedule candidates corresponding to a plurality of dataflow combinations of the same mapping candidates, may be identified as the neural network computation schedule.

Likewise, when neural network computation data may be transmitted and received between adjacent memory hierarchies according to various dataflows, the neural network computing device 100 according to an embodiment of the present disclosure may perform scheduling in consideration of the dataflow as well as hardware mapping. As such, the neural network computing device 100 may identify a neural network computation schedule having further lower computation costs.

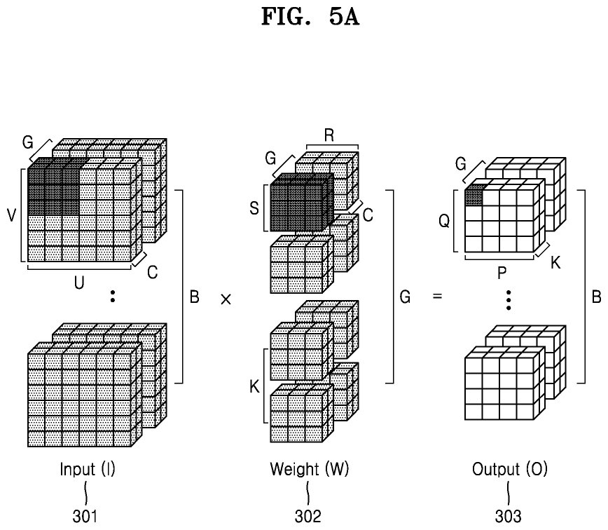

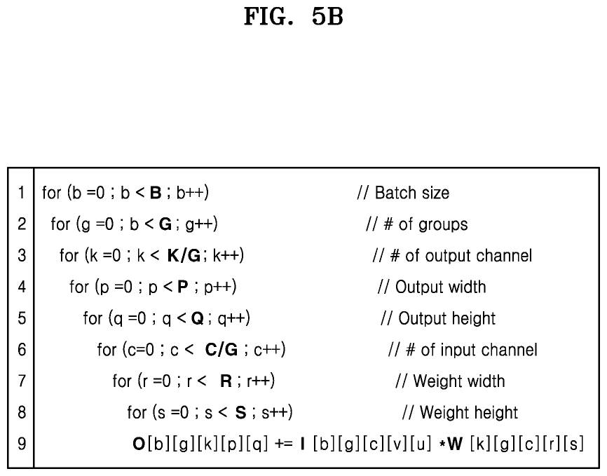

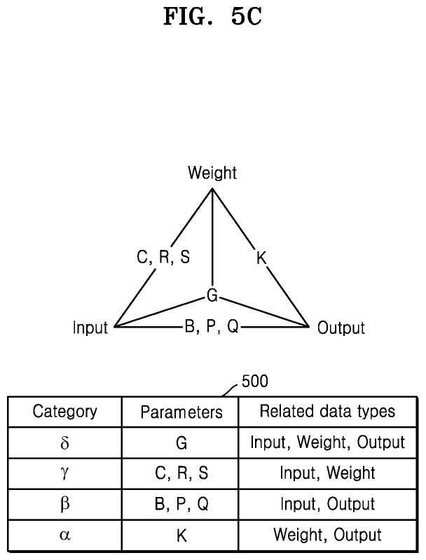

FIGS. 5A to 5C are diagrams of a neural network parameter according to an embodiment of the present disclosure;

Referring to FIG. 5A, a general convolution layer is shown. In a general convolution layer, output data 303 may be generated by performing convolution operation for input data 301 and weight data 302. At this time, there may be parameter values related to the type and size of each data set. The parameter values may be neural network parameters 500 used in hardware mapping of the present disclosure.

Specifically, the neural network parameters 500 may include a plurality of input data parameters related to the factor of input data 301, a plurality of weight data parameters related to the factor of weight data 302, and a plurality of output data parameters related to the factor of output data 303.

The input data parameters may include parameters related to at least one of a batch size B, an input channel C, a group size G, an input height V, and an input width U of input data 301.

The weight data parameters may include parameters related to at least one of a weight channel C, a group size G, a weight count K, a weight height S, and a weight width R of weight data 302.

The output data parameters may include parameters related to at least one of a batch size B, a group size G, an output count K, an output height Q, and an output width P of output data 303.

Moreover, the height V and the width U of the input data 301 may derived from other neural network parameters 500. For example, in the case of a convolution neural network layer, the height V and the width U of input data 301 may be calculated using formulas U=(P−1)×stride+R and V=(Q−1)×stride+S. That is, the input V and the width U of the input data 301 are neural network parameters 500 which may be differently derived depending on the type of the neural network layer.

The values of the neural network parameters 500 may be factorized to thereby be allocated to the spatial level and the temporal level of the neural network computing device 100 as mapping values.

Referring to FIG. 5B, it may be seen that the convolution operation process is expressed by pseudo codes. At this time, the parameter related to group G may be one of types of convolution, such as a depth-wise convolution layer which exists in MobileNet, etc. When G=1, the illustrated codes may mean a general convolution.

The loop on each neural network parameter 500 is shown on the pseudo code, in a duplicated form. Specifically, parameters B, K, P, and Q of the output data 303 are repeated in an external loop, and parameters C, R, and S, which are not related to parameters of the output data 303, are repeated in an internal loop. This shows a case where an OS dataflow occurs in that data about parameters B, K, P, and Q of output data 303, which are repeated in the external loop, are fixed.

Likewise, scheduling may be performed by changing the loop order on the pseudo code. In this case, however, the scheduling process may become much more complicated when considering a multi-hierarchy structure of the neural network computing device 100, the storage capacity and the number of components of a plurality of memory hierarchies, etc.

Referring to FIG. 5C, the correlation between neural network parameters 500 may be seen. One parameter may be related to two or three data sets.

For example, category α may be a category of parameters related to weight data 302 and output data 303, and may include count K. Category β may be a category of parameters related to input data 301 and output data 303 and may include the batch size B, the height Q of the output data 303, and the width P of the output data 303. Category γ may be a category of parameters related to input data 301 and weight data 302 and may include the channel C, the height S of weight data 302, and the width R of weight data 302. Category δ may be a category of parameters related to input data 301, weight data 302 and output data 303, and may include group G.

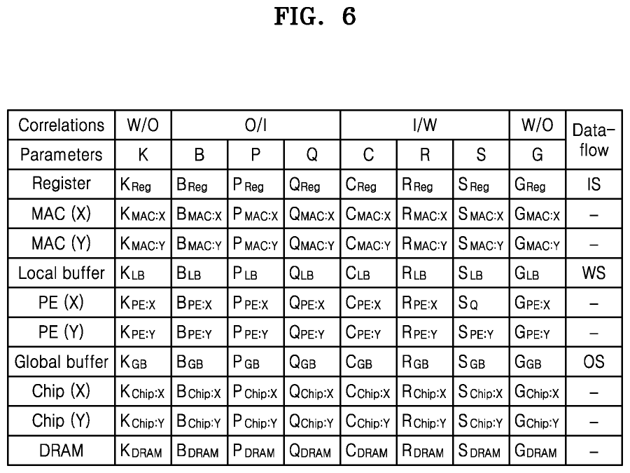

FIG. 6 is a diagram of a scheduling table according to an embodiment of the present disclosure.

The processor 130 may perform hardware mapping of neural network computation data using a scheduling table 600.

It may be seen that all temporal levels and spatial levels of the neural network computing device 100, from MAC which is the uppermost operator (e.g., 120 of FIG. 1), to DRAM which is the lowest memory hierarchy, are alternately listed in one column of the scheduling table. In addition, it is seen in one column of the mapping table that neural network parameters 500 are listed according to the correlation.

Each space of the scheduling table may include the mapping value (mapping degree). Here, the factor of the value of a certain neural network parameter 500 may be allocated to a column corresponding to the neural network parameter 500, as the mapping value. As such, the product of all mapping values of a certain column may be the same as the value of the neural network parameter 500 corresponding to the column. For example, if the count (K) value of the neural network parameter 500 is 128, the product of K_{Reg}, K_{MAC:X}, K_{MAC:Y}, K_{LB}, K_{PE:X}, K_{PE:Y}, K_{GB}, K_{Chip:X}, K_{Chip:Y}, and K_{DRAM} may be 128.

In addition, it may be seen in one column of the scheduling table that a dataflow is allocated to a plurality of memory hierarchies. Here, the dataflow may mean a dataflow of neural network computation data which is transmitted and received between a memory hierarchy of a column, to which the dataflow has been allocated, and a low level memory hierarchy adjacent to the memory hierarchy of the column. For example, when the dataflow of a column corresponding to a global buffer is an OS dataflow, neural network computation data, which is transmitted and received between the global buffer and DRAM, may be moved along the OS dataflow. Mapping values allocated to each space of the scheduling table may include information on hardware mapping about the level corresponding to a row including the space. That is, the processor 130 may allocate mapping values to spaces of a certain row of the scheduling table, and may perform hardware mapping about the level corresponding to the row.

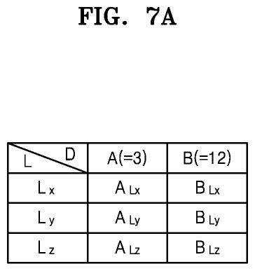

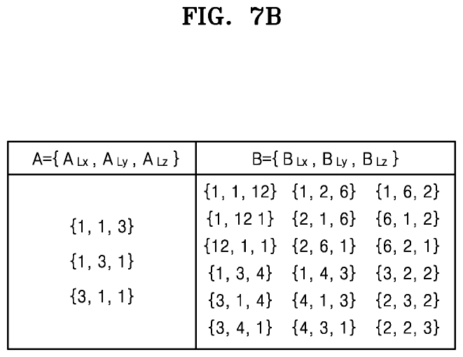

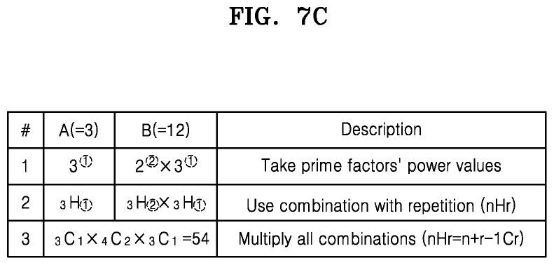

FIGS. 7A to 7C are diagrams illustrating a method of calculating the number of combinations of mapping values which may be allocated to a scheduling table, according to an embodiment of the present disclosure;

Referring to FIG. 7A, factors of neural network parameter A and neural network parameter B in a scheduling table may be allocated to a plurality of levels Lx, Ly, and Lz of the neural network computing device 100. In this case, the product of mapping values Alx, Aly, and Alz of the column corresponding to neural network parameter A may be 3, which is the value of neural network parameter A, and the product of mapping values Blx, Bly, and Blz of the column corresponding to neural network parameter B may be 12, which is the value of the neural network parameter B.

Referring to FIG. 7B, combinations of factors of neural network parameter A and combinations of factors of neural network parameter B, which may be allocated to Lx, Ly, and Lz levels of the neural network computing device 100, may be shown in the scheduling table. As such, the number of combinations of mapping values, which may be allocated to the scheduling table, may be 54, which is the product of 3 (i.e., the number of combinations of factors of neural network parameter A) and 18 (i.e., the number of combinations of factors of neural network parameter B).

Referring to FIG. 7C, the number of combinations of mapping values, which may be allocated to the scheduling table, may be calculated, based on the combination with repetition of the number n of levels of the neural network computing device 100 of the scheduling table, and index r of prime factors, which are obtained by factorizing the value of the neural network parameter into prime factors.

As such, it may be seen that as the number of the types of neural network parameters and the number of levels of the neural network computing device increase, the number of combinations of mapping values, which may be allocated to the scheduling table, rapidly increases.

Moreover, in a scheduling method that includes calculating computation costs for all combinations of mapping values which may be allocated to the scheduling table, and determining a combination of mapping values having the lowest computation costs, an excessively large amount of combinations of mapping values should be calculated, and thus, there may be a problem that scheduling takes excessively long time.

In contrast, the neural network computing device 100 according to an embodiment of the present disclosure does not calculate computation costs for all combinations of mapping values which may be allocated to the scheduling table. Instead, the neural network computing device 100 according to an embodiment may select at least one of combinations of mapping values which may be allocated in a certain level section, and then select one of combinations of mapping values, which may be allocated in the next level section, for only the selected combination of mapping values. As such, the number of combinations of mapping values, in which computation costs should be calculated, may be significantly reduced, and consequently, time required for performing scheduling is reduced.

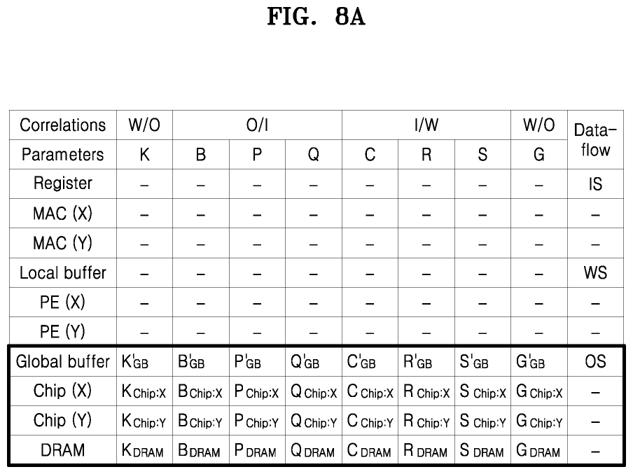

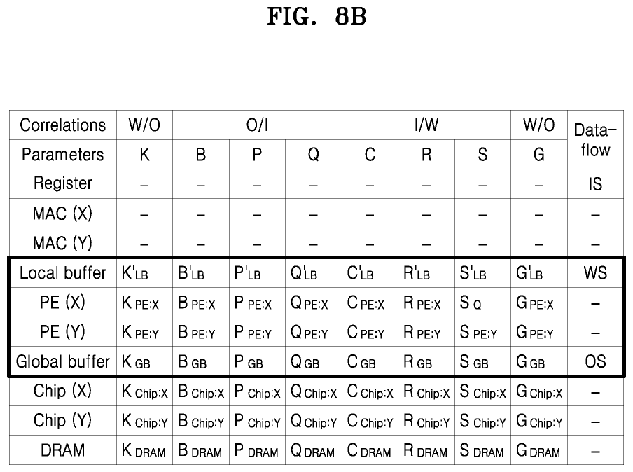

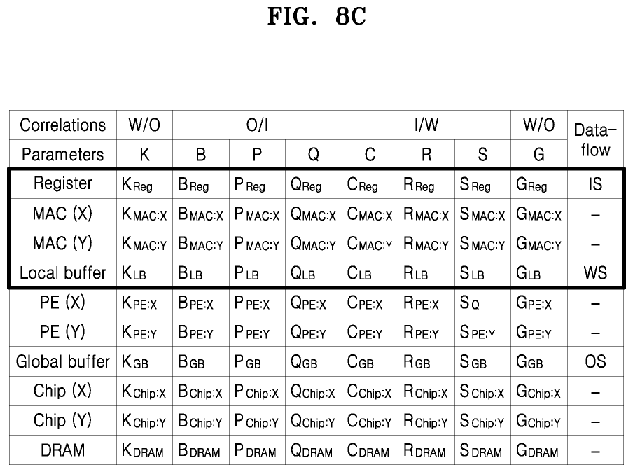

FIGS. 8A to 8C are diagrams illustrating a process of performing bottom-up scheduling using a scheduling table, according to an embodiment of the present disclosure;

The processor 130 may perform bottom-up scheduling by sequentially allocating mapping values from the lowest level section to the highest level section of the scheduling table.

Specifically, the processor 130 may first allocate mapping values to a certain level section, and then allocate mapping values to the next level section. Here, there may be hardware mapping corresponding to the combination of mapping values allocated to the certain level section. In other words, allocating mapping values to a certain level section of the scheduling table may correspond to hardware mapping performed in each sequence illustrated in FIG. 4. Hardware mapping will be described below.

Referring to FIG. 8A, the processor 130 may perform hardware mapping from DRAM, which is the lowest level section among a plurality of levels of the neural network computing device 100, to a global buffer.

Specifically, the processor 130 may identify combinations of a plurality of mapping values from DRAM to the global buffer of the scheduling table. The product of all mapping values allocated to a certain column corresponds to the value of the neural network parameter 500 corresponding to the column. Here, the combinations of a plurality of mapping values may correspond to a plurality of identified mapping candidates described with reference to FIG. 4.

In addition, the processor 130 may identify combinations of the plurality of mapping values which satisfy constraint conditions, among the combinations of the plurality of identified mapping values. Here, combinations of mapping values, which satisfy constraint conditions, may correspond to mapping candidates which satisfy constraint conditions described with reference to FIG. 4.

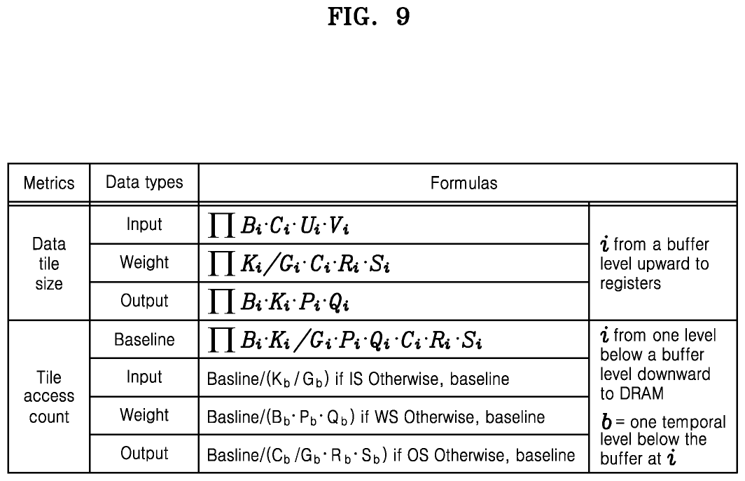

The data tile size of neural network computation data, which is determined based on the combinations of mapping values, may need to be equal to or smaller than the storage capacity of the memory hierarchy which loads the neural network computation data. A specific method of calculating the data tile size is described below with reference to FIG. 9.

In addition, the required number of components, which is determined based on the combinations of mapping values, may need to be equal to or smaller than the available number of components, depending on constraint conditions. Here, the required number of components may be equal to the product of mapping values allocated to the row of the component.

In addition, the processor 130 may select one of combinations of a plurality of mapping values which satisfy constraint conditions, and may perform hardware mapping for the selected combination from DRAM to the global buffer of the scheduling table. Here, mapping values, which are allocated to the row corresponding to the global buffer of the scheduling table, are temporarily allocated mapping values, and may vary depending on the hardware mapping which is performed in the next operation.

Referring to FIG. 8B, after hardware mapping is performed from DRAM to the global buffer, the processor 130 may perform hardware mapping from the global buffer to the local buffer.

Specifically, the processor 130 may identify the combination of the plurality of mapping values from the global buffer to the local buffer of the scheduling table. The product of all of mapping values are allocated to a certain column corresponds to the mapping value of the global buffer in the column which is temporarily allocated by the previous hardware mapping.

In addition, the processor 130 may identify combinations of the plurality of mapping values, which satisfy constraint conditions, among the combinations of the plurality of identified mapping values.

In addition, the processor 130 may select one of combinations of a plurality of mapping values, which satisfy constraint conditions, and may perform hardware mapping for the selected combination from the global buffer to the local buffer of the scheduling table. Here, mapping values, which are allocated to the row corresponding to the local buffer of the scheduling table, are temporarily allocated mapping values, and may vary depending on the hardware mapping, which is performed in the next operation.

Referring to FIG. 8C, after hardware mapping is performed from the global buffer to the local buffer, the processor 130 may perform hardware mapping from the local buffer to the register. The hardware mapping process performed in FIG. 8C is the same as what has been described with reference to FIG. 8B, and thus, repeated descriptions thereof will be omitted.

Likewise, after hardware mapping is performed from the local buffer to the register, mapping values may be allocated to all spaces of the scheduling table. In addition, the scheduling table, in which mapping values are allocated to all spaces, may correspond to a certain neural network computation schedule.

In an embodiment, the processor 130 may select at least one of combinations of a plurality of mapping values which satisfy constraint conditions, based on at least one of the first strategy, the second strategy, the third strategy, and the fourth strategy described above, and may perform hardware mapping for the selected combination. As such, a plurality of scheduling tables, where mapping values have been allocated to all spaces, may be generated. The generated scheduling tables may correspond to a plurality of schedule candidates described with reference to FIG. 4.

In order to identify at least one of combinations of a plurality of mapping values which satisfy constraint conditions, based on the first strategy, the processor 130 may calculate the data tile size of the neural network computation data and the number of times of the neural network computation data, based on the mapping values. Here, the number of times of access of the neural network computation data may mean the number of times the neural network computation data is loaded from a low level memory hierarchy to an high level memory hierarchy in order to perform a convolution operation. In addition, the processor 130 may calculate energy or time required for the movement of neural network computation data, based on the data tile size and the number of times of access. As such, the processor 130 may select the combination of mapping values, which has the lowest movement costs among combinations of a plurality of mapping values which satisfy constraint conditions, and may perform hardware mapping for the selected combination.

In order to identify at least one of combinations of a plurality of mapping values which satisfy constraint conditions, based on the second strategy, the processor 130 may identify the data tile size of the neural network computation data, based on the mapping values. In addition, the processor 130 may select the combination of mapping values, which has the largest data tile size among combinations of a plurality of mapping values, and may perform hardware mapping for the selected combination.

In order to identify at least one of combinations of a plurality of mapping values which satisfy constraint conditions, based on the third strategy, the processor 130 may select a combination of mapping values where the product of numbers of factors of each mapping value, which is allocated to the row of a high level memory hierarchy, is the largest among a plurality of combinations of a plurality of mapping values which satisfy constraint conditions, based on the mapping values, and may perform hardware mapping for the selected combination.

In order to identify at least one of combinations of a plurality of mapping values which satisfy constraint conditions, based on the fourth strategy, the processor 130 may identify neural network computation data which is not influenced by the dataflow of neural network computation data which is transmitted and received in the next level section. In addition, the processor 130 may identify the data tile size of neural network computation data, which is not influenced by the dataflow, based on the mapping values. In addition, the processor 130 may select mapping candidates in which the data tile size of neural network computation data, which is not influenced by the dataflow, is smaller than the storage capacity of a second-high level memory hierarchy, among a plurality of combinations of mapping values, and perform hardware mapping for the selected mapping candidates.

In an embodiment, the processor 130 may select each combination of a plurality of mapping values satisfying constraint conditions when scheduling the uppermost level section of the neural network computing device 100. For example, when the processor 130 performs hardware mapping from a local buffer to a register, the processor 130 does not identify a combination of mapping values based on the first to third strategies, but may perform hardware mapping by selecting each combination of a plurality of mapping values satisfying the constraint conditions.

FIG. 9 is a diagram illustrating a method of calculating the data tile size and movement costs of neural network computation data, based on mapping values allocated to a scheduling table, according to an embodiment of the present disclosure.

Referring to FIG. 9, the data tile size may be calculated, based on mapping values allocated to the row of a high level memory hierarchy, to which the data tile is loaded in the scheduling table. Specifically, the input data tile size may be calculated, based on mapping values of input data parameters B, C, U, and V. In addition, the weight data tile size may be calculated, based on mapping values of weight data parameters K, G, C, R, and S. In addition, the output data tile size may be calculated, based on mapping values of output data parameters B, K, P, and Q.

Here, the mapping values of input data parameters U and V may not be values allocated on the scheduling table and may be values derived, based on mapping values of other parameters, as described with reference to FIG. 5A. For example, in the case of a convolution neural network layer, the mapping value of input data parameters U and V may be calculated using formulas U=(P−1)×stride+R and V=(Q−1)×stride+S.

The total data tile size may be the sum of the input data tile size, the weight data tile size, and the output data tile size. In addition, the data tile size may need to be equal to or smaller than the storage capacity of a memory hierarchy which loads the data tile.

Referring to FIG. 9, the number of times of access of neural network computation data may be calculated, based on mapping values allocated to the row of a low level memory hierarchy, to which the data tile is loaded in the scheduling table. Specifically, the baseline value may be calculated based on the mapping values of a plurality of neural network parameters B, K, G, P, Q, C, R, and S. In addition, the number of times of access of each of input data, weight data, and output data may be calculated, based on the dataflow of the baseline and neural network computation data.

The number of times of access per data point of input data, weight data, and output data may be calculated by multiplying each of the input data tile size, the weight data tile size, and the output data tile size by the number of times of access of the data.

Movement costs of neural network computation data, which are required for each of a low level memory hierarchy and a high level memory hierarchy, may be calculated based on the number of times of access per data point.

The movement costs of neural network computation data, which is transmitted and received between adjacent memory hierarchies, may be calculated by the sum of movement costs of neural network computation data of a high level memory hierarchy, and movement costs of neural network computation data of a low level memory hierarchy.

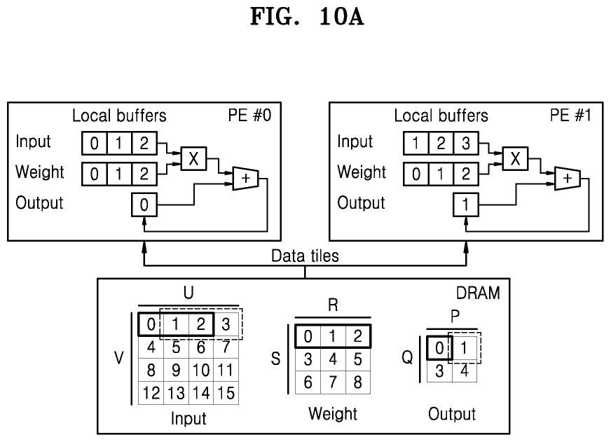

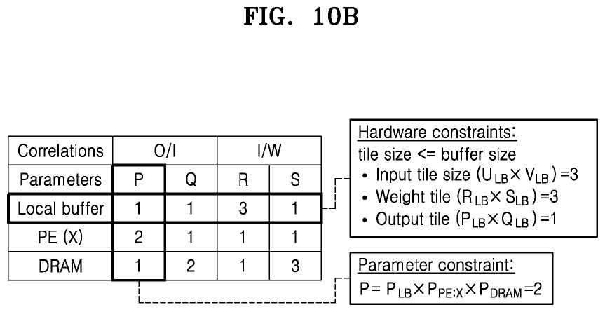

FIGS. 10A and 10B are diagrams illustrating the combination of mapping values which satisfy constraint conditions, according to an embodiment of the present disclosure.

Referring to FIG. 10A, neural network computation data 300, which is stored in the DRAM, may be transmitted and received between the DRAM and local buffers, based on a certain neural network computation schedule.

Here, neural network parameters R and S of neural network computation data 300 have a value of 3, and P and Q may have a value of 2. The remaining neural network parameters may have a value of 1. Neural network parameters U and V may be determined, based on mapping values allocated to the row of a high level memory hierarchy in the scheduling table.

Referring to FIG. 10B, the combination of mapping values allocated to the scheduling table may correspond to the neural network computation schedule for neural network computation data, which is transmitted and received between the DRAM and local buffers.

Specifically, the neural network parameters of FIG. 10A may be allocated as mapping values between the DRAM and local buffers of the scheduling table. As such, it may be seen that the product of all of mapping values of each column of the scheduling table is the same as the value of the neural network parameter corresponding to the corresponding column of FIG. 10A.

In this case, the combination of allocated mapping values may satisfy constraint conditions about the data tile size. Specifically, it may be calculated that the data tile size of input data is 3, the data tile size of weight data is 3, and the data tile size of output data is 1, based on the mapping values of the neural network parameters allocated to the row of local buffers of the scheduling table. It may be seen that the combination of mapping values satisfies constraint conditions about the data tile in that the calculated data tile sizes are equal to or smaller than the storage capacity of local buffers of FIG. 10A.

In addition, the required number of components of the processing element, which are arranged in the X-axis, may be calculated as 2 by multiplying mapping values of the row. It may be seen that the combination of mapping values satisfies constraint conditions about the required number of components in that the calculated required number is equal to or smaller the number for the X-axis of the processing element of FIG. 10A.

Likewise, the neural network computing device 100 according to an embodiment of the present disclosure may perform bottom-up scheduling using a scheduling table. However, the method of performing bottom-up scheduling is not limited thereto, and the bottom-up scheduling may be performed based on other means.

In response to the performance of the components described above, at least one component may be added or deleted. In addition, it will be easily understood by one of ordinary skill in the art that the mutual location of the components may be changed according to the performance or structure of the system.

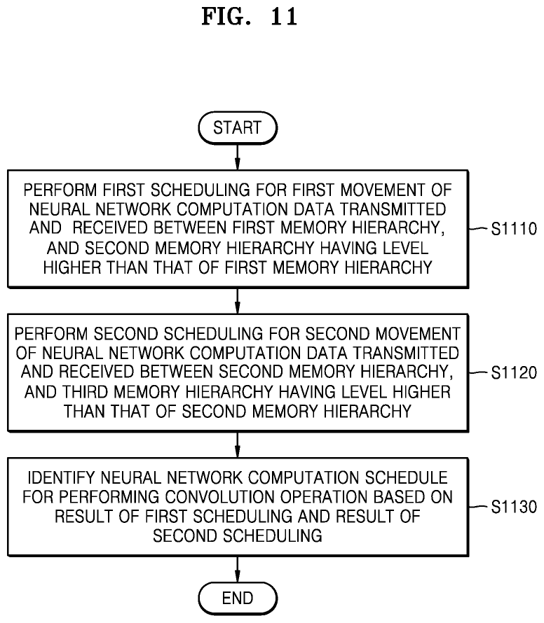

FIG. 11 is a flowchart illustrating a method of controlling a neural network computing device, according to an embodiment of the present disclosure. The flowchart of FIG. 11 shows only one embodiment for achieving the purpose of the present disclosure, and some operations may be added or deleted as needed.

First of all, a method of controlling a neural network computing device includes performing first scheduling about a first movement of neural network computation data, which is transmitted and received between a first memory hierarchy and a second memory hierarchy having a level higher than that of the first memory hierarchy (S1110).

In addition, in the method of controlling the neural network computing device, when the first scheduling is performed, second scheduling for a second movement of neural network computation data, which is transmitted and received between the second memory hierarchy, and a third memory hierarchy having a level higher than that of the second memory hierarchy, is performed (S1120).

In addition, in the method of controlling the neural network computing device, a neural network computation schedule for performing a convolution operation, based on the result of the first scheduling and the result of the second scheduling, is identified (S1130).

In an embodiment, in operation S1110, the first scheduling may be performed based on at least one of a plurality of strategies. In operation S1120, after the first scheduling is performed, the second scheduling may be performed based on at least one of the plurality of strategies. In operation S1130, a plurality of schedule candidates may be identified, based on the result of the first scheduling and the result of the second scheduling.

In this case, the plurality of strategies may include a first strategy for enhancing the utilization rate of a low level memory hierarchy among a plurality of memory hierarchies, a second strategy for enhancing the utilization rate of a high level memory hierarchy among the plurality of memory hierarchies, a third strategy for keeping a balance between the utilization rate of the high level memory hierarchy and the utilization rate of the low level memory hierarchy, and a fourth strategy for preventing repeated transmission and reception of neural network computation data.

In an embodiment, in operation S1110, the first scheduling may be performed for each of a plurality of dataflow combinations, which are generated based on the dataflow of the first movement and the dataflow of the second movement. In operation S1120, after the first scheduling is performed, the second scheduling may be performed for each of a plurality of dataflow combinations.

In this case, the dataflow may be determined, based on the parameter about which the data is reused among a plurality of neural network parameters of neural network computation data.

In an embodiment, in operation S1110, when the first scheduling is performed based on the first strategy, the first scheduling may be performed to minimize movement costs of neural network computation data for the first movement. In operation S1120, when the second scheduling is performed based on the first strategy, the second scheduling may be performed to minimize movement costs of neural network computation data for the second movement.

In this case, the movement costs may include at least one of energy and time required for transmission and reception of the neural network computation data.

In an embodiment, in operation S1110, when the first scheduling is performed based on the second strategy, the first scheduling may be performed to maximize the data tile size of neural network computation data for the first movement. In operation S1120, when the second scheduling is performed based on the second strategy, the second scheduling may be performed to maximize the data tile size of neural network computation data for the second movement.

In an embodiment, in operation S1110, when the first scheduling is performed based on the third strategy, the first scheduling may be performed to maximize the number of mapping candidates for the second movement. In operation S1120, when the second scheduling is performed based on the third strategy, the second scheduling may be performed to maximize the number of mapping candidates for the third movement of neural network computation data which is transmitted and received between the third memory hierarchy and a fourth memory hierarchy having a level higher than that of the third memory hierarchy.

In an embodiment, in operation S1110, when the first scheduling is performed based on the fourth strategy, the first scheduling may be performed so that neural network computation data is not repeatedly transmitted and received in the second movement. In addition, in operation S1120, when the second scheduling is performed based on the fourth strategy, the second scheduling may be performed so that neural network computation data is not repeatedly transmitted and received in the third movement of neural network computation data which is transmitted and received between the third memory hierarchy and a fourth memory hierarchy having a level higher than that of the third memory hierarchy.

In an embodiment, the plurality of schedule candidates may satisfy constraint conditions which are determined based on at least one of the storage capacity of a plurality of memory hierarchies and the number of components including the plurality of memory hierarchies.

In an embodiment, operation S1130 may include identifying computation costs required for performing the convolution operation for each of a plurality of schedule candidates, and identifying a schedule candidate, which has the smallest computation costs, as the neural network computation schedule, among a plurality of schedule candidates.

In an embodiment, a method of controlling a neural network computing device may further include performing a convolution operation based on the identified neural network computation schedule.

Moreover, details of the method of performing the first scheduling, the method of performing the second scheduling, and the method of identifying the neural network computation schedule are as described above. As such, the method of controlling a neural network computing device of the present disclosure may significantly reduce time required for performing a scheduling, by calculating computation costs for only selected schedule candidates without calculating computation costs for all schedule candidates which may be applicable to the neural network computing device. Furthermore, the neural network computation schedule identified through the scheduling may have computation costs similar to those of a schedule candidate having the lowest computation costs, among all schedule candidates.

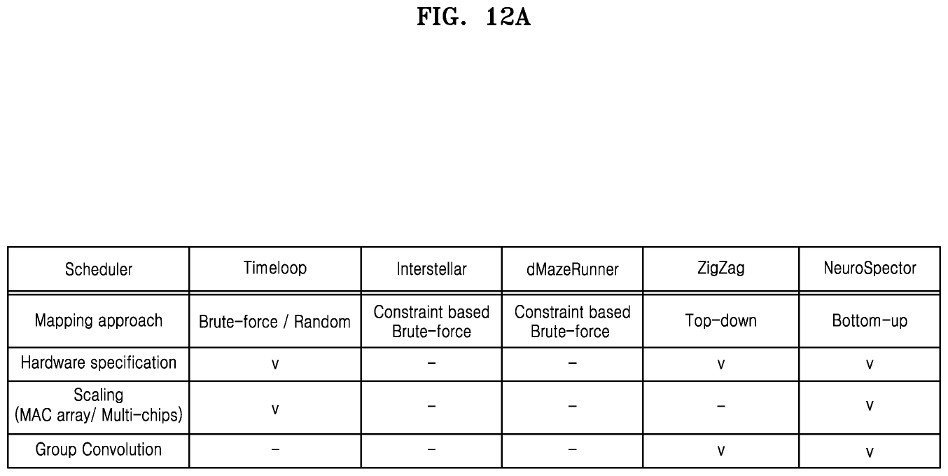

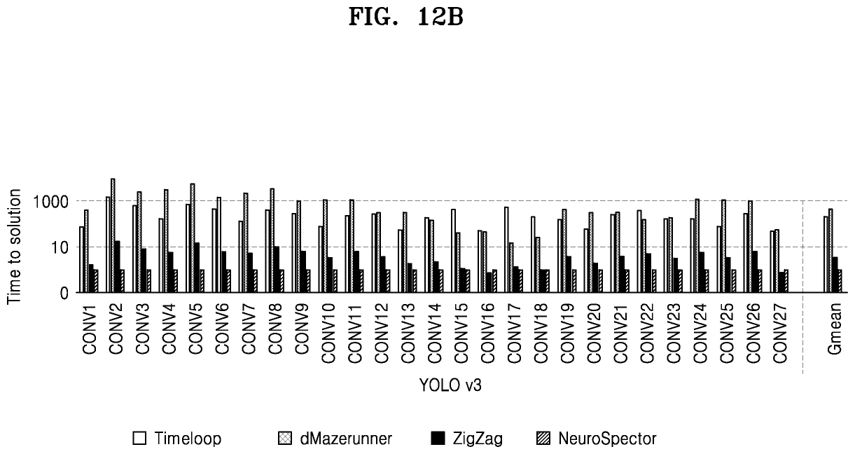

FIGS. 12A and 12B show a table and a graph of comparing a scheduling method according to an embodiment of the present disclosure with a scheduling method according to a conventional art.

In order to verify the performance of the neural network computing device 100 according to an embodiment of the present disclosure, a neural network computation experiment based on YOLO was conducted.

Referring to FIG. 12A, it may be seen various scheduling methods including a scheduling method (NeuroSpector) according to an embodiment of the present disclosure are disclosed.

Referring to FIG. 12B, it may be seen that the speed of completing scheduling of the scheduling method (NeuroSpector) according to an embodiment of the present disclosure is higher than that of the conventional scheduling method.

Specifically, it may be seen from the experiment that the scheduling method (NeuroSpector) according to an embodiment of the present disclosure is 201.8 times faster than Timeloop (Random-search) method on average and is 465.8 times faster than dMazeRunner method on average.

In addition, it may be confirmed from the result of the experiment that the scheduling method (NeuroSpector) according to an embodiment of the present disclosure is 3.5 times faster than Zigzag method on average and is superior to Zigzag method in terms of the accuracy of finding scheduling.

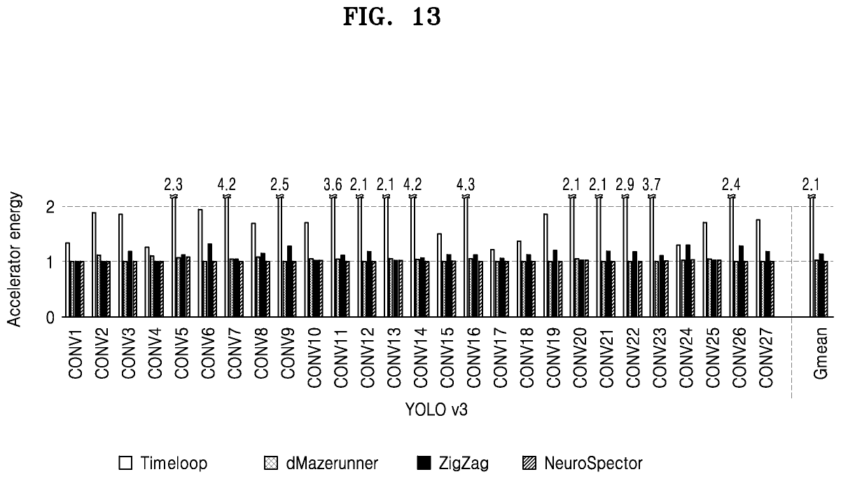

FIG. 13 is a graph for explaining the accuracy of a neural network computation schedule identified by a scheduling method according to an embodiment of the present disclosure.

Referring to FIG. 13, Timeloop (Random-search) method iteratively selects a random schedule candidate that satisfies a constraint conditions and determine an optimal schedule candidate. That is, since the Timeloop (Random-search) method randomly selects a schedule candidate that satisfies the constraint conditions, there is a high possibility that an optimal schedule candidate cannot be found. dMazeRunner method determine the optimal schedule having the lowest computation costs while checking all schedule candidates which satisfy constraint conditions.

However, the dMazeRunner method may need to spend a long time to determine the optimal schedule candidate. In contrast, in Zigzag method and the neural network computing method (NeuroSpector) method of the present disclosure, the optimal schedule candidate may be relatively quickly determined because not all schedule candidates, which satisfy constraint conditions, are checked.

When the energy value, which is represented by the vertical axis of the graph, is closer to 1, it indicates that the energy costs of the determined neural network computation schedule are closer to the lowest energy costs in each scheduling method. Therefore, it was seen that the accuracy of the neural network computing method (NeuroSpector) of the present disclosure is higher than that of Zigzag method.

It was confirmed by experiments that a similar trend was shown in various accelerators and other networks, such as MobileNet and AlexNet, in addition to Yolo.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A neural network computing device for generating output data by performing a convolution operation of input data and weight data, the neural network computing device comprising:
a memory including a plurality of memory hierarchies, and configured to store neural network computation data including the input data, the weight data, and the output data; and
a processor configured to:
perform first scheduling for a first movement of the neural network computation data between a first memory hierarchy and a second memory hierarchy having a higher level than the first memory hierarchy;
after the first scheduling is performed, perform second scheduling for a second movement of the neural network computation data between the second memory hierarchy and a third memory hierarchy having a higher level than the second memory hierarchy; and
identify a neural network computation schedule for performing the convolution operation, based on a result of the first scheduling and a result of the second scheduling.

2. The neural network computing device of claim 1, wherein
the processor performs the first scheduling based on at least one of a plurality of strategies, performs the second scheduling based on at least one of the plurality of strategies, identifies a plurality of schedule candidates based on the result of the first scheduling and the result of the second scheduling, and identifies one of the plurality of schedule candidates as the neural network computation schedule, and
the plurality of strategies include a first strategy for enhancing a utilization rate of a low level memory hierarchy among the plurality of memory hierarchies, a second strategy for enhancing a utilization rate of a high level memory hierarchy among the plurality of memory hierarchies, a third strategy for keeping a balance between the utilization rate of the high level memory hierarchy and the utilization rate of the low level memory hierarchy, and a fourth strategy for preventing repeated transmission and reception of the neural network computation data.

3. The neural network computing device of claim 2, wherein
the processor performs the first scheduling and the second scheduling for each of a plurality of dataflow combinations which are generated based on a dataflow of the first movement and a dataflow of the second movement, and
the dataflow is determined based on a parameter about which data is reused, among a plurality of neural network parameters of the neural network computation data.

4. The neural network computing device of claim 2, wherein the processor:
performs the first scheduling based on the first strategy to minimize movement costs of the neural network computation data which performs the first movement; and
performs the second scheduling based on the first strategy to minimize movement costs of the neural network computation data which performs the second movement,
wherein the movement costs include at least one of energy and time required for transmission and reception of the neural network computation data.

5. The neural network computing device of claim 2, wherein the processor:
performs the first scheduling based on the second strategy to maximize a data tile size of the neural network computation data which performs the first movement; and
performs the second scheduling based on the second strategy to maximize a data tile size of the neural network computation data which performs the second movement.

6. The neural network computing device of claim 2, wherein the processor:
performs the first scheduling based on the third strategy to maximize a number of mapping candidates for the second movement; and
performs the second scheduling based on the third strategy to maximize the number of mapping candidates for the third movement of the neural network computation data between the third memory hierarchy and a fourth memory hierarchy having a higher level than the third memory hierarchy.

7. The neural network computing device of claim 2, wherein the processor:
performs the first scheduling based on the fourth strategy to prevent repeated transmission and reception of the neural network computation data in the second movement; and
performs the second scheduling based on the fourth strategy to prevent repeated transmission and reception of the neural network computation data in the third movement of the neural network computation data between the third memory hierarchy and a fourth memory hierarchy having a higher level than the third memory hierarchy.

8. The neural network computing device of claim 2, wherein
the plurality of neural network parameters include a plurality of input data parameters related to factors of the input data, a plurality of weight data parameters related to factors of the weight data, and a plurality of output data parameters related to factors of the output data, and
the dataflow is one of an input stationary (IS) dataflow where data related to the input data parameters is reused, a weight stationary (WS) dataflow where data related to the weight data parameters is reused, and an output stationary (OS) dataflow where data related to the output data parameters is reused.

9. The neural network computing device of claim 2, wherein the plurality of schedule candidates satisfy constraint conditions, which are determined based on at least one of a storage capacity of the plurality of memory hierarchies, and a number of components including the plurality of memory hierarchies.

10. The neural network computing device of claim 2, wherein the processor:
identifies computation costs required for performing the convolution operation for each of the plurality of schedule candidates; and
identifies a schedule candidate, which has smallest computation costs among the plurality of schedule candidates, as the neural network computation schedule,
wherein the computation costs include at least one of energy and time required for performing the convolution operation.

11. The neural network computing device of claim 1, further comprising an operator for performing the convolution operation, wherein the processor controls the operator to perform the convolution operation based on the neural network computation schedule.

12. A method of controlling a neural network computing device, which generates output data by performing a convolution operation of input data and weight data, and uses a memory which includes a plurality of memory hierarchies and is configured to store neural network computation data including the input data, the weight data, and the output data, the method comprising:
performing first scheduling for a first movement of the neural network computation data between a first memory hierarchy and a second memory hierarchy having a higher level than the first memory hierarchy;
after the first scheduling is performed, performing second scheduling for a second movement of the neural network computation data between the second memory hierarchy and a third memory hierarchy having a higher level than the second memory hierarchy; and
identifying a neural network computation schedule for performing the convolution operation, based on a result of the first scheduling and a result of the second scheduling.

13. The method of claim 12, wherein
the performing of the first scheduling includes the performing the first scheduling based on at least one of a plurality of strategies,
the performing of the second scheduling includes performing the second scheduling based on at least one of the plurality of strategies,
the identifying of the neural network computation schedule includes:
identifying a plurality of schedule candidates based on the result of the first scheduling and the result of the second scheduling; and
identifying one of the plurality of schedule candidates as the neural network computation schedule, and
the plurality of strategies include a first strategy for enhancing a utilization rate of a low level memory hierarchy among the plurality of memory hierarchies, a second strategy for enhancing a utilization rate of a high level memory hierarchy among the plurality of memory hierarchies, a third strategy for keeping a balance between the utilization rate of the high level memory hierarchy and the utilization rate of the low level memory hierarchy, and a fourth strategy for preventing repeated transmission and reception of the neural network computation data.

14. The method of claim 13, wherein
the performing of the first scheduling includes performs the first scheduling for each of a plurality of dataflow combinations which are generated based on a dataflow of the first movement and a dataflow of the second movement,
the performing of the second scheduling includes performing the second scheduling for each of the plurality of dataflow combinations, and
the dataflow is determined based on a parameter about which data is reused among a plurality of neural network parameters of the neural network computation data.

15. The method of claim 13, wherein
the performing of the first scheduling includes performing the first scheduling based on the first strategy to minimize movement costs of the neural network computation data which performs the first movement,
the performing of the second scheduling includes performing the second scheduling based on the first strategy to minimize movement costs of the neural network computation data which performs the second movement, and
the movement costs include at least one of energy and time required for transmission and reception of the neural network computation data.

16. The method of claim 13, wherein
the performing of the first scheduling includes performing the first scheduling based on the second strategy to maximize a data tile size of the neural network computation data which performs the first movement, and
the performing of the second scheduling includes performing the second scheduling based on the second strategy to maximize a data tile size of the neural network computation data which performs the second movement.

17. The method of claim 13, wherein
the performing of the first scheduling includes performing the first scheduling based on the third strategy to maximize a number of mapping candidates for the second movement, and
the performing of the second scheduling includes performing the second scheduling based on the third strategy to maximize the number of mapping candidates for the third movement of the neural network computation data between the third memory hierarchy and a fourth memory hierarchy having a higher level than the third memory hierarchy.

18. The method of claim 13, wherein the performing of the first scheduling includes performing the first scheduling based on the fourth strategy to prevent repeated transmission and reception of the neural network computation data in the second movement, and
wherein the performing of the second scheduling includes performing the second scheduling based on the fourth strategy to prevent repeated transmission and reception of the neural network computation data in the third movement of the neural network computation data between the third memory hierarchy and a fourth memory hierarchy having a higher level than the third memory hierarchy.

19. The method of claim 13, wherein the identifying of the neural network computation schedule includes:
identifying computation costs required for performing the convolution operation for each of the plurality of schedule candidates; and
identifying a schedule candidate, which has smallest computation costs among the plurality of schedule candidates, as the neural network computation schedule,
wherein the computation costs include at least one of energy and time required for performing the convolution operation.

20. A computer program stored in a non-transitory computer-readable recording medium to execute the method of controlling a neural network computing device of claim 12.
